(19) United States
(12) Patent Application Publication
(10) Pub. No.: US 2005/0038358 A1
(43) Pub. Date: Feb. 17, 2005

(54) Guide wire and production method therefor

(76) Inventor: Kazutoshi Furukawa, Tochigi (JP)

Correspondence Address: MEYERTONS, HOOD, KIVLIN, KOWERT & GOETZEL, P.C., P.O. BOX 398, AUSTIN, TX, 78767-0398, US

(21) Appl. No.: 10/496,441

(22) PCT Filed: Nov. 25, 2002
(86) PCT No.: PCT/JP02/12291

(30) Foreign Application Priority Data
Nov. 26, 2001 (JP) 2001-359968

(51) Int. Cl. B29C 31/00

(52) U.S. Cl. 600/585; 264/259; 600/434

(57) ABSTRACT

A guide wire comprising an inner core (a) having, integrally formed together, a body portion (a-1) high in rigidity and a tip end portion (a-2) smaller in diameter and lower in rigidity than the (a-1), an a high X-ray contrast unit (b) provided at the (a-2), the (a-2) being resin-molded with the (b) contained therein, wherein the guide wire having the high X-ray contrast unit (coil) integrally formed with resin allows no blood to enter the coil, no thrombus to be formed, and the coil not to shrink or expand or come off when the guide wire is to be removed, and an elastomer used for metal powder-contained rubber portion at the front tip end is soft and not likely to damage blood vessels, whereby it is possible to materialize a very fine guide wire having an inner core with an outer diameter of 0.25-0.31 mm.

### TECHNICAL FIELD

The invention relates to an innovative guide wire and its production method. More particularly, the invention relates to a guide wire comprising a high x-ray contrast unit and an inner core integrated by resin molding and its production method.

### BACKGROUND OF THE INVENTION

For inspection and treatment of a human body, a catheter is commonly inserted into the tissues and the coeloms of a human body such as the blood vessel, the trachea, the urethra and the like. At the time of leading the catheter to an aimed point of the body, a guide wire is used for guiding the catheter to the aimed point while being inserted into the catheter and its tip end being slightly projected out of the tip of the catheter. Further, recently, it has been tried to introduce the catheter into a thinner blood vessel such as inner blood vessels of the brain or blood vessels composing the kidney and thus the catheter is need to be further thinner and accordingly, the guide wire is also required to be thin (Japanese Patent Application Laid-Open No. 2-180277).

However, it has been difficult to make an ultra-thin guide wire practically available since there have been various problems and obstacles. For example, a guide wire for the brain comprises the main part of the tapered part covered with a coil (a high x-ray contrast unit) and therefore no main tip end portion with a lubricating property can be obtained. Further, since there is a space between the core wire and the coil in the main part, blood enters in the space to be a thrombus or if the guide wire once has a habit of curving, it cannot be amended. For example, once a doctor fails to make the shape of a guide wire as he likes, it cannot be amended. No extremely thin guide wire with an outer diameter of 0.25 to 0.31 mm and sufficient for practical use exists. Further, a metal such as a silver solder is used for the most tip end portion, so that the blood vessel is sometimes damaged.

Based on the investigations carried out for solving such problems, inventors have developed a guide wire having a specified structure and a guide wire coated with a lubricating coating by a specified production method using a specified material to solve the above-mentioned problems and accordingly have accomplished the invention.

### BRIEF DESCRIPTION OF THE DRAWINGS

The drawing in the left of FIG. 1 is a perspective view showing a guide wire of the invention at the time of production and the drawing in the right is its vertical cross-sectional view.

FIG. 2 is a vertical cross-sectional view of a guide wire completed.

FIG. 3 is a cross-sectional view showing the method of an underwater lubrication test.

FIG. 4 is a graph showing the result of the underwater lubrication test.

### DESCRIPTION OF THE SYMBOLS

1 an inner core
2 a tip end portions
3 high x-ray contrast unit (coil-like) 4 a tube made of resin 5 a tube made of a metal 6 a seal member
7 a plug
8 a main body parts
9 the most tip end portion (corresponding to semicircular rubber)
10 x-ray contrast unit comprising integrally formed resin and coil
11 a coil and resin
12 a lubricating coating 13 a cylindrical container 14 a cylinder 15 a silicone sheet
16 an opening parts 17 a sample

### DISCLOSURE OF THE INVENTION

A purpose of the invention is to provide a guide wire with high safety which comprises a high x-ray contrast unit (a coil) and resin integrated together so as to prevent blood from entering in the coil and forming a thrombus and of which the coil is prevented from expansion and contraction or from coming off when the guide wire is taken out.

Another purpose of the invention is to make a guide wire comprising an inner core with an outer diameter of 0.25 to 0.31 mm practically available.

Further another purpose of the invention is to provide a guide wire which has a lubricating coating with durability in an optional length, uses an elastomer for the most tip end portion of a metal powder-mixed rubber, is soft and hardly damages the blood vessel.

That is, the invention is as described in the following guide wires of (1) to (IV):
(I) a guide wire comprising an inner core (a) composed of a main body portion (a-1) with a high rigidity and a tip end portion (a-2) smaller in diameter and lower in rigidity than the main body portion (a-1) and integrally formed together with the main body portion (a-1) and a high x-ray contrast unit (b) formed at the tip end portion (a-2), wherein the tip end portion (a-2) is resin-molded with the (b) contained therein;
(II) the guide wire wherein the tip end of the tip end portion (a-2) is made of a metal powder-mixed rubber;
(III) the guide wire wherein the surface is entirely or partially coated with a lubricating coating; and
(IV) a production method of the above-mentioned guide wire by inserting the tip end portion (a-2) portion into a tube with a larger outer diameter than that of the tip end portion (a-2) and injecting a resin raw material into the tube for resin-molding the tip end portion (a-2) containing the (b) and then drawing out the tip end portion (a-2) from the tube.
   Best Modes of the Invention

With respect to the invention (I), the inner core (a) is composed of the main body portion (a-1) with a high rigidity and the tip end portion (a-2) smaller in diameter and lower in rigidity than the main body portion (a-1). A conventionally known material may be used as the material for composing the inner core (a) and examples of the material include super elastic metallic bodies such as a stainless steel, a Ti—Ni alloy, a Cu—Zn alloy, a Ni—Al alloy, a Cu—Zn—X alloy (X=Be, Si, Sn, Al, Ga and the like) and a preferable alloy is a stainless steel or a Ti—Ni alloy and a more preferably alloy is a Ti—Ni alloy. The materials composing the main body portion (a-1) and the tip endportion (a-2) may be similar or dissimilar to each other.

The outer diameter of the main body portion (a-1) of the inner core (a) is preferably 0.10 to 1.50 mm, more preferably 0.15 to 0.41 mm, and furthermore preferably 0.25 to 0.31 mm. The length is preferably 500 to 4,000 mm, more preferably 1,500 to 3,000 mm, and furthermore preferably 1,800 to 2,500 mm. The buckling strength (the yield stress at the time of load) is preferably 30 to 100 kg/mm² (22° C.) and more preferably 40 to 55 kg/mm² (22° C.).

The outer diameter of the tip end portion of the inner core (a-2) is smaller than the outer diameter of the main body portion (a-1) and preferably it becomes smaller toward the tip end. In this case, it is preferable to carry out tapering and the outer diameter of the most tip end portion is preferably 0.01 to 0.1 mm and more preferably 0.02 to 0.05 mm. The length is preferably 10 to 400 mm and more preferably 50 to 300 mm. The bending load and the restoring load are preferably 0.1 to 10 g and more preferably 0.3 to 6.0 g.

It ifs no need that the main part portion (a-1) and the tip end portion (a-2) have same restoring stress, or rather preferably they have proper physical properties with proper wire diameters by changing the thermal treatment conditions. Further, the inner core (a) is not limited to a single wire and maybe composed of a plurality of wires to have the above-mentioned functions, that is, physical properties changing in steps or continuously.

The high x-ray contrast unit (b) is at the tip end of the inner core (a) and is a circular member of a metal having a high x-ray contrasting ability and practically it is a coil-like or pipe-like member and preferably it is a coil-like member. Examples of the metal having the high x-ray contrasting ability are gold, platinum, silver, bismuth, tungsten and the like and preferable examples are gold and platinum. It is further preferable for the tip end portion (a-2) to have a further tip end part in 10 cm or less, preferably 5 cm or less, in the length made of gold or platinum. The unit (b) is preferable to cover the main part of the tip end portion (a-2) and therefore has a wider outer diameter than the outer diameter of the tip end portion (a-2). That is, the outer diameter of the high x-ray contrast unit is preferably 0.1 to 1.5 mm, more preferably 0.15 to 0.41 mm, and furthermore preferably 0.2 to 0.31 mm. The inner diameter is preferably 0.04 to 1.4 mm, more preferably 0.06 to 0.30 mm, and furthermore preferably 0.08 to 0.15 mm. The length is preferably 10 to 400 mm and more preferably 50 to 300 mm.

The guide wire of the invention comprises the tip end portion (a-2) of the inner core (a) which is resin-molded with the high x-ray contrast unit (b) included therein. The outer diameter of the portion formed by resin-molding is equal to or smaller than the outer diameter of the main part portion of the main part portion (a-1). The outer diameter maybe either uniform at both ends of the tip end portion (a-2) or tapered to be smaller toward the tip end portion. The uniform outer diameter is more preferable.

The molded resin is not particularly limited if it is an elastomer and is not softened in the inside of a human body, and the tensile strength of the elastomer is preferably 50 kg/cm² or higher, more preferably 100 to 400 kg/cm 2, furthermore preferably 200 to 400 kg/cm². The 300% modulus is preferably 40 kg/cm or less, more preferably 5 to 30 kg/cm 2, and furthermore preferably 5 to 20 kg/cm². The elongation is preferably 200% or higher and more preferably 300 to 1,000%. The measurement methods of these properties are based on ASTM D412. The heat resistance is preferably high enough to stand for continuous use at 60° C. or higher. The wear resistance is preferably 0.1 to 0.3 and more preferably 0.15 to 0.25, on the basis of the dynamic friction coefficient. The wear resistance is measured according to the following method.

(Evaluation Method of the Wear Resistance)

The wear resistance is evaluated on the basis of dynamic friction coefficient of the molded resin surface. The dynamic friction coefficient is measured by measuring that between a friction member formed by bending a steel wire with a diameter of 0.5 mm and the resin surface under the conditions of 20 g load and 1 mm/s speed by using KES-FB-4 S manufactured by Kato-Tech. Co.

As the material for the elastomer, practically, at least one or more elastomers selected from elastomer resins such as polyolefins (polyethylene, polypropylene, and the like), ethylene-vinyl acetate copolymers, poly vinyl chloride, polyesters, polyamides, polyurethanes, polystyrene, epoxy resins, fluorocarbon resins, silicone resins, and/or their mixtures and compounded products can be exemplified. Preferable examples are polyethylene, polyesters, polypropylene, polyurethanes, fluorocarbon resins, and silicone resins which are highly safe to the human body and more preferable examples are polyesters, polyurethanes, silicone resins, and fluorocarbon resins which have high elasticity and furthermore preferable examples are polyurethanes with high wear resistance and adhesion strength.

As the raw materials (c) forming these elastomers, there are non-reactive type (c-1) and reactive type (c-2) from another point of view.

The non-reactive type (c-1) may preferably include those among the above-mentioned elastomers having a weight average molecular weight of 10,000 and 1, 000,000 and a softening point of 60° C. or higher. That is preferable because if the molecular weight is in the above-mentioned range, the elastomer is thermally fusible and moldable and if the softening point is 60° C. or higher, it is not softened in the human body temperature. The reactive type (c-2) is preferably oligomers or polymers with a weight average molecular weight of 500 to 500,000 and more preferably 1,000 to 300,000 and having functional groups at the terminals or side chains to be higher polymers by curing at the time of molding. The reactive type (c-2) is further preferably those having functional groups at the terminals. That is because those having the functional groups at the terminals are excellent in the elongation of the resulting resins after curing as compared with those having the functional groups at the side chains. Examples of the functional groups are those causing reaction at a normal temperature or by heating and practical examples are isocyanate group (free, block type), epoxy group, unsaturated groups (double bond groups), amido group, hydroxyl, carboxylic acid group, sulfonic acid group, acid anhydride group, acid halide group, a lower alkoxy group, amino group, diazonium group, azide group, aldehyde group, N-methylol group, iminocarbonic acid ester, silanol group, hydrolyzable silyl group [tri- or di-alkoxy (of 1 to 3 carbon atoms) silyl] and the like. Those having one or more of these functional groups in each molecule are preferable.

Among these functional groups, further preferable groups are functional groups causing additional reactions and examples are isocyanate group, epoxy group, hydroxyl group, N-methylol group, aldehyde group, and amino group (primary amino group and secondary amino group). In the case of additional reaction, no byproduct is produced by condensation, and therefore, no foam remains in the molded product.

The types of the resins forming the skeleton of the reactive type (c-2) are those same as the resin described in the above explanation of the raw materials (c). Among the raw materials of the resins, preferable examples are polyethylene, polyesters, polypropylene, polyurethanes, fluorocarbon resins, and silicone resins and more preferable examples are polyesters, polyurethanes, silicone resins, and fluorocarbon resins and furthermore preferable examples are polyurethanes.

Among the raw materials (c), the reactive type (c-2) is preferable. That is because in the case of a reactive type, a further higher molecular weight polymer is obtained by the reaction and no non-reactive low molecular weight polymer compound is left, so that a substance safe and harmless to a human body can be obtained. As the reactive type (c-2), those comprising the functional groups having addition reactivity in the molecular terminals as described above are preferable and particularly, so-called urethane prepolymers, urethane oligomers comprising functional groups in the terminals are preferable. Urethane oligomers can be obtained by reaction of polyisocyanates and polyols.

As the polyisocyanates, those having two or more isocyanate groups in each molecule, more preferably 2 to 4 isocyanate groups, are preferable and practical examples are as follows. (I) Polyisocyanate

| | | | |
|---|---|---|---|
| diisocyanate | (TDI); | crude TDI; | 2,4′-4,4′-diphenylmethane |
| diisocyanate | (MDI); | crude MDI; | 4,4′-diisocyanatebiphenyl; |

3,3′-dimethyl-4,4′-diisocyanatebiphenyl; 3,3′-dimethyl-4,4′-diisocyanatediphenylmethane; 1,5-naphthylenediisocyanate; 4,4′,4″-triphenylmethanetoly isocyanate; m- and/or p-isocyanatephenylsulfonyl isocyanate; polyaryl polyisocyanate (PAPI), and the like:

(ii) Aliphatic polyisocyanates of 2 to 18 carbon atoms; ethylene diisocyanate, hexamethylene diisocyanate (HDI), tetramethylene diisocyanate, dodecamethylene diisocyanate, 1,6,11-undecane triisocyanate, 2,2,4-trimethylhexamethylene diisocyanate, lysine diisocyanate, 2,6-diisocyanatemethylcaproate, bis(2-isocyanateethyl) fumarate, bis(2-isocyanateethyl) carbonate, 2-isocyanateethyl-2,6-diisocyanatehexanoate, trimethylhexamethylene diisocyanate (TMDI), and dimer acid diisocyanate (DDI), and the like.

(iii) Alicyclic polyisocyanates of 4 to 15 carbon atoms; isophorone diisocyanate (IPDI), dicyclohexyl diisocyanate, dicyclohexylmethane diisocyanate (H-MDI), cyclohexylene diisocyanate, hydrogenated tolylenediisocyanate (HTDI), bis(2-isocyanateethyl)-4-cyclohexene-1,2-dicarboxylate, 2,5- and/or 2,6-norbornanediisocyanate and the like.

(iv) Aromatic aliphatic polyisocyanates of 8 to 15 carbon atoms.-m- and/or p-xylenediisocyanate (XDI), a,a,a′, a′-tetramethylxylylenediisocyanate (TMXD) and the like.

(v) Modified compounds of the above-mentioned polyisocyanates;

modified products containing urethane group, carbodiimido group, allophanate group, urea group, biuret group, urethodione group, urethonimine group, isocyanurate group, or oxazolidone group; examples of the modified compounds are polyol (the following low molecular weight and/or high molecular weight polyol) adducts of polyisocyanates [the mole ratio of NCO/OH is preferably (1.01 to 10)/1 and more preferably (1.1 to 5)/1 and an adduct of trimethylolpropane 1 mole and the above-mentioned diisocyanate 3 mole; an adduct of pentaerythritol and the above-mentioned diisocyanate 4 mole.

(vi) Diisocyanate polymers; isocyanurates of the above-mentioned polyisocyanate (trimers, pentamers), biurets of the above-mentioned diisocyanates (trimers, pentamers) and the like. Two or more of these polymers may be used in combination. Among them, preferable polyisocyanates are those belonging the groups (ii) and (iv) and more preferably (ii) and furthermore preferably HDI.

Examples of polyols are those having preferably 2 or more and more preferably 2 to 4 hydroxyl groups and practical examples are polyalkylene ether polyol (1), polyester polyol (2), polymer polyol (3), polybutadiene polyol (4), castor oil-based polyol (5), acryl polyol (6), and mixtures of two or more of these polyols. The number average molecular weight of the polyols is generally 500 to 20,000, preferably 500 to 10,000, and furthermore preferably 1,000 to 3,000.

Polyalkylene ether polyol (1), compounds obtained by adding alkylene oxide (hereinafter abbreviated as AO) to active hydrogen atom-containing polyfunctional group (D) and mixtures of two or more of these compounds can be exemplified.

Examples of (D) are polyhydric alcohols (d-1), polyhydric phenols (d-2), amines (d-3), polycarboxylic acids (d-4), phosphoric acids (d-5), polythiols (d-6) and the like. alcohols such as ethylene glycol, propylene glycol, 1,3-butylene glycol, 1,4-butanediol, 1,6-hexanediol, diethylene glycol, neopentyl glycol, bis(hydroxymethyl)cyclohexane, and bis (hydroxyethyl) benzene; and poly hydric (tri- to octa-hydric) alcohols such as glycerin, trimethylolpropane, pent aerythritol, diglycerin, a-methyl glucoside, sorbitol, xylitol, mannitol, dipentaerythritol, glucose, fructose, sucrose and the like.

Examples of polyhydric phenols (d-2) are polyhydric phenols such as pyrogallol, catechol, and hydroquinone and in addition to them, bisphenols such as bisphenol A, bisphenol F,

Examples of polyhydric alcohols (d-1) are dihydric bisphenol S and the like.

Examples of amines (d-3) are monoamines such as ammonia, alkylamines of 1 to 20 carbon atoms (butylamine), and aniline; aliphatic polyamines ethylenediamine, trimethylenediamine, hexamethylenediamine, and diethylenetriamine; piperazine, N-aminoethylpiperazine and heterocyclic polyarines described in Japanese Patent Application Publication No. 55-21044; alicyclic polyamines such as dicyclohexylmethanediamine, and isophoronediamine; aromatic polyamines such as phenylenediamine, tolylenediamine, diethyltolylenediamine, xylylenediamine, diphenylmethanediamine, diphenyletherdiamine, and polyphenylmethanepolyamine; and alkanolamines such as monoethanolamine, diethanolamine, triethanolamine, triisopropanolamine, and the like.

Examples of polycarboxylic acids (d-4) are aliphatic polycarboxylic acids such as succinic acid and adipic acid and aromatic polycarboxylic acids such as phthalic acid, terephthalic acid, and trimellitic acid.

Examples of phosphoric acids (d-5) are phosphoric acid, phosphorous acid, phosphonic acid, and mono- or dialkyl (1 to 10 carbon atoms) esters of them. Examples of polythiols (d-6) are polyhydric thiolcompounds obtained by reaction of glycidyl-containing compounds and hydrogen sulfide. Two or more kinds of the above-mentioned active hydrogen atom-containing compounds (D) can be used.

As AO to be added to the (D), ethylene oxide (EO), propylene oxide (PO), 1,2-, 2,3-, or 1,3-butylene oxide, tetrahydrofuran (THF), styrene oxide, a-olefin oxide, epichlorohydrin and the like.

AO may be used solely or two or more may be used in combination and in the latter case, block-addition (tipped type, balanced type, active secondary type and the like) or random-addition or their mixed system [those tipped after random addition; those having 0 to 50% by weight (5 to 50% by weight) of ethylene oxide chains distributed randomly in molecule and tipped with EO chains 0 to 30% by weight (preferably 5 to 25% by weight) at the molecular terminals may be used. Among the above exemplified A0, preferable examples are solely E0, solely P0, solely THF, a combination of PO and E0, and a combination of THF with PO and/or EO (in the case of combination, random, block and mixed system of them).

The addition of AO to (D) can be carried out by a common method and in the absence or in the presence of a catalyst (an alkali catalyst, an amine type catalyst, an acidic catalyst, a metal complex catalyst and the like), it is carried out at a normal pressure or a pressurized condition (especially in the latter half of the AO addition step) in one step or multi-steps. Further, the polyalkylene ether polyol (1) may include those having a further increased molecular weight by further reaction with a small ratio [equivalent ratio of polyalkylene ether polyol/polyisocyanate: preferable (1.2 to 10)/1, more preferably (1.5 to 2)/1] of a polyisocyanate (which will be exemplified later).

The equivalent of the polyalkylene ether polyol (1) (the molecular weight per hydroxyl group) is preferably 100 to 10,000, more preferably 250 to 5,000, and furthermore preferably 500 to 1,500. Further, the functionality value of the polyalkylene ether polyol (1) is preferably 2 to 8, more preferably 2 to 3, and furthermore preferably 2. The unsaturated degree of the polyalkylene ether polyol (1) is preferably low, more preferably 0.1 meq/g or lower, more preferably 0.05 meq/g or lower, and furthermore preferably 0.02 meq/g or lower. The content ratio of primary hydroxyl group of the polyalkylene ether polyol (1) is preferably 0 to 100%, more preferably 30 to 100%, furthermore preferably 50 to 100%, and most preferably 70 to 100%.

Examples of the polyester polyol (2) include condensed polyester diols obtained by reaction of low molecular weight diols and/or polyalkylene ether diols having a molecular weight of 1,000 or less with dicarboxylic acids; polylactonediols obtained by ring-opening polymerization of lactone; and polycarbonate diols obtained by reaction of carbonic acid diesters with low molecular weight diols and lower alcohols (methanol or the like).

Examples of the above-mentioned low molecular weight diols include ethylene glycol, diethylene glycol, propylene glycol, dipropylene glycol, 1,4-, 1,3-butanediol, neopentyl glycol, 1,6-hexanediol; low molecular weight diols having cyclic groups [e.g. those described in Japanese Patent Application Publication No. 45-1474; bis(hydroxymethyl)cyclohexane, bis (hydroxyethyl) benzene, bisphenol A-ethylene oxide adduct] and mixtures of two or more of them.

Examples of polyalkylene ether diols with a molecular weight of 1,000 or less include polytetramethylene ether glycol, polypropylene glycol, polyethylene glycol, and mixture of two or more of these glycols.

Further, examples of dicarboxylic acid include aliphatic dicarboxylic acid (succinic acid, adipic acid, azelaic acid, sebacic acid and the like), aromatic dicarboxylic acid (terephthalic acid, isophthalic acid, phthalic acid and the like), and ester-forming derivatives of these dicarboxylic acids [acid anhydrides, lower alkyl (1 to 4 carbon atoms) esters] and mixtures of two or more of them and examples of lactone include E-caprolactone, y-butylolactone, y-valerolactone, and mixtures of two or more of them. Polyesterification may be carried out by a normal method, for example, by reaction (condensation) of low molecular weight diols and/or polyether diols having a molecular weight 1,000 or lower with dicarboxylic acid or their ester-formable derivatives [e.g. anhydrides (maleic anhydride and phthalic anhydride), lower esters (dimethyl adipate and dimethyl terephthalate), halides] or their anhydride and alkylene oxide (e.g. ethylene oxide and/or propylene oxide) or adding lactone to imitators (low molecular weight diols and/or polyether diols having a molecular weight 1,000 or lower).

Practical examples of these polyester polyols (2) are polyethylene adipate diol, polybutylene adipate diol, polyhexamethylene adipate diol, polyneopentyl adipate diol, polyethylenepropylene adipate diol, polyethylenebutylene adipate diol, polybutylenehexamethylene adipate diol, polyethylene adipate diol, poly(polytetramethylene ether) adipate diol, polyethylene azelate diol, polyethylene sebacate diol, polybutylene azelate diol, polybutyrene sebacate diol, polycaprolactone diol or triol, polyhexamethylene carbonate diol.

Examples of the polymer polyol (3) include those obtained by polymerizing radical polymerizable monomers [e.g. styrene, (meth)acrylonitrile, (meth) acrylic acid esters, vinyl chloride, and mixtures of two or more of them] in polyols (the above-mentioned polyalkylene ether polyols and/or polyester polyols) and dispersing the obtained polymers.

In general, polymerization initiators are used for polymerizing these monomers. As the polymerization initiators, azo compounds for producing radical groups for starting polymerization such as 2,2′-azobisisobutyronitrile (AIBN), 2,2′-azobis-(2,4-dimethylvaleronitrile) (AVN); dibenzoyl peroxide, dicumyl peroxide, peroxides described in Japanese Patent Application Laid-Open No. 61-76517 other than those described above, persulfates, perborates, and persuccinic acid can be used and practically azo compounds, particularly AIBN and AVN are preferable. The use amount of the polymerization initiators is preferably 0.1 to 20% by mass and more preferably 0.2 to 10% by mass on the basis of the full amount of the monomers.

The polymerization reaction in polyols can be carried out without a solvent, however in the case of a high polymerization concentration, it is preferable to carry out in the presence of an organic solvent. As the solvent, for example, benzene, toluene, xylene, acetonitrile, ethyl acetate, hexane, heptane, dioxane, N,N-dimethylformamide, N,N-dimethylacetamide, isopropyl alcohol, and n-butanol are exemplified. Further, the polymerization can be carried out in the presence of known chain transfer agents except for alkylmercaptans (tetrachlorocarbon, tetrabromocarbon, chloroform, enol ethers described in Japanese Patent Application Laid-Open No. 55-31880) based on the necessity.

The polymerization can be carried out in a batch mode or a continuous mode. The polymerization reaction can be carried out at a temperature equal to or higher than the decomposition temperature of the polymerization initiators, preferably 60 to 180° C., more preferably 90 to 160° C., further preferably 100 to 150° C. under the atmospheric pressure or pressurized condition or vacuum condition.

On completion of the polymerization reaction, the obtained polymer polyols may be used as they are for polyurethane production without adding any post-treatment, however it is preferable to remove the organic solvents, the decomposition products of the polymerization imitators and impurities of the un-reacted monomers by conventional means after the completion of the reaction.

Examples of the polymer polyol (3) obtained in such a manner preferably include semi-transparent or opaque white or yellowish brown color dispersions comprising the entire monomers of which 30 to 70%, preferably 40 to 60%, further preferably 45 to 55%, most preferably 50 to 55%, that is, polymers, dispersed in polyols. The hydroxyl value of the polymer polyols (3) is preferably 10 to 300, more preferably 20 to 250, and furthermore preferably 30 to 200.

The polybutadiene polyol (4) includes those having 1,2-vinyl structure, 1,2-vinyl structure and 1,4-trans structure, and 1,4-trans structure. The ratio of the 1,2-vinyl structure and 1,4-trans structure on the basis of mole can be changed variously, for example, (100:0) to (0:100). The polybutadiene glycol (4) further includes homopolymers and copolymers (styrene butadiene copolymers, acrylonitrile butadiene copolymers, and the like) and their hydrogenated ones (hydrogenation ratio: for example 20 to 1000). The number average molecular weight of the polybutadiene glycol (4) is preferably 500 to 10,000.

Practical examples of the polybutadiene glycol (4) include those having the following general formulas (1) to (3): HO—C—C—CV-C— (C—CV) n-C—CV-C—C—OH (1), OH-[(C—C═C—C)ₐ(C-CV)_{c}(C—C═C—C)b]ₙ—OH (2), and OH-[(C—C═C—C)ₐ(CX—C)_{b}]ₙ—OH (3) [wherein —C— denotes —CH2—; —C═C— denotes —CH═CH—; —CV- denotes —C(CH═CH2) H—; and —CX— denotes —C(X)H—; and X denotes phenyl or nitrile group].

The polybutadiene glycols defined by the general formula (1) are, for example, those given in the case n is 15 to 80; the polybutadiene glycols defined by the general formula (2) are, for example, those given in the case n is 50 to 55, a is 0, 2, b is 0.6, and C is 0.2; and the polybutadiene glycols defined by the general formula (3) are, for example, those given in the case n is 78 to 87, a is 0,75, and b is 0.25.

Commercialized products defined by the general formula (1) are NISSO-PB G series (products manufactured by Nippon Soda Co., Ltd. and practically, G-1000, G-2000, and G-3000 can be exemplified. Commercialized products defined by the general formulas (2) and (3) are Poly Bd (products of US ARCO) and practically, Poly Bd R-45M, R-45HT, CS-15, and CN-15 can be exemplified.

The castor oil-based polyol (5) includes castor oil and modified castor oil (caster oil modified by polyhydric alcohols such as trimethylol propane, pentaerythritol).

The ratio of the hydroxyl of the polyol and isocyanate of polyisocyanate on the basis of mole is preferably (1:2) to (2.:1), more preferably (1:1.5) to (1.5:1), furthermore preferably (1:1.2) to (1.2:1).

If the hydroxyl group is excess, prepolymers having hydroxyl groups at terminals are obtained and if the isocyanate group is excess, isocyanate group-terminated urethane prepolymers are obtained. Further, based on the necessity, the polymers may contain an urethanization promoting catalyst, a filler, a plasticizer, an antioxidant, an UV absorbent and the like.

The mixing ratio of the urethanization promoting catalyst is preferably 0 to 10% by mass and more preferably 0.01 to 5% by mass in the entire urethane polymer. The mixing ratio of the filler_is preferably 5 to 50% by mass and more preferably 10 to 30% by mass. The mixing ratio of the antioxidant is preferably 0.001 to 10% by mass and more preferably 0.01 to 5% by mass. The mixing ratio of the UV adsorbent is preferably 0.001 to 10% by mass and more preferably 0.01 to 5% by mass.

Examples of the urethanization promoting catalyst are tin type catalysts such as trimethyltin laurate, trimethyltin hydroxide, dimethyltin dilaurate, dibutyltin diacetate, dibutyltin dilaurate, stanous octoate, and dibutyltin maleate; lead type catalysts such as lead oleate, lead 2-ethylhexanate, lead naphthenate, and lead octanate; naphthenic acid metal salts such as cobalt naphthenate, phenylmercuryl propionate; triethylenediamine, tetramethylethylenediamine, tetramethylhexylenediamine, diazabicycloalkenes; and amine type catalysts and their organic acid salts (formic acid salt and the like) such as dimethylaminoethylamine, dimethylaminopropylamine, diethylaminopropylamine, dibutylaminoethylamine, dimethylaminooctylamine, dipropylaminopropylamine, 2-(1-aziridinyl)ethylamine, 4-(1-piperidinyl)-2-hexylamine, N-methylmorpholine, N-ethylmorpholine, triethylamine, diethylethanolamine, dimethylethanolamine; and mixtures of two or more of them. The addition ratio of the urethanization promoting catalyst in the invention is preferably 0 to 10% by mass and more preferably 0.01 to 5% by mass in the entire urethane prepolymer.

Examples of the filler is clay, heavy calcium carbonate, calcium carbonate surf ace treated with fatty acid, barium sulfate, alumina, silica, carbon black, calcium oxide, titanium oxide, diatomaceous earth, glass fiber and its crushed substances (cut glass, milledglass, glass flakes and the like), shirasu-balloon, carbon fiber, potassium titanate, boron fiber, gypsum fiber, talc, mica, wollastonite, calcium silicate, chalk, glass beads, and quartz. The addition ratio of the filler is preferably 5 to 50% by mass and more preferably 10 to 30 o by mass in the entire I injection type uretha i4 resin composition.

Examples of the plasticizer are phthalic acid ester-based plasticizers (dibutyl phthalate, dioctyl phthalate and the like); phosphoric acid triester type plasticizers (triphenyl phosphate, tricresyl phosphate and the like); aliphatic dibasic acid esters type plasticizers [dibutyl sebacate, dioctyl adipate, di(2-ethylhexyl) adipate, polyethylene glycol (molecular weight: 200) diadipate, and the like]; fatty acid ester type plasticizers (methyl acetyl ricinolate and the like); polyester type plasticizers (adipic acid-propylene glycol esters and the like); polyhydric alcohol type plasticizers (triethylene glycol dibenzoate and the like); citric acid ester type plasticizers (triethyl citrate and the like); and petroleum resin type plasticizers and the like. The addition ratio of the plasticizer is preferably 5 to 70% by mass and more preferably 15 to 50% by mass.

Examples of the antioxidant are hindered phenol type antioxidants [Irganox 1010 (Ciba-Geigy Corp.), octadecyl⁻3⁻(3,5-di-tert-butyl-4-hydroxyphenyl)propionate (Irganox 1076 manufactured by Ciba-Geigy Corp.) and the like]; hindered amine type antioxidant [(Sanol LS 770 manufactured by Sankyo Co., Ltd.), 4⁻benzoyloxy-2,2,6,6-tetramethylpiperidine (Sanol LS 744 manufactured by Sankyo Co., Ltd.) and the like]. The addition amount of the antioxidant is preferably 0.001 to 10% by mass and more preferably 0.01 to 5% by mass.

Examples of the UV adsorbent are triazole type UV adsorbents [2-(5-methyl-2-hydroxyphenyl) benzotriazole and Tinuvin 320 (Ciba-Geigy Corp.) and the like]; benzophenone type UV adsorbent [2-hydroxy-4-methoxybenzophenone, Cyasorb UV 9 (manufactured by Cyanamid Ltd.) and the like]. The addition amount of the UV adsorbent is preferably 0.001 to 10% by mass and more preferably 0.01 to 5% by mass. The method of producing the urethane prepolymer is not particularly limited and, for example, a prepolymer method by producing an isocyanate group-terminated prepolymer by carrying out reaction of a polyol and an excess amount of a polyisocyanate at 50 to 120° C., preferably 70 to 100° C. and successively carrying out reaction of the prepolymer and a low molecular weight diol and a one-shot method by carrying out a polyol compound obtained by mixing a polyol and a low molecular weight diol with a polyisocyanate. The reaction with polyisocyanate is carried out, for example, by a method of measuring the respective components and stirring the respective components; and a method by measuring the components with a quantitative pump, fiercely mixing and stirring the components, pouring to a butt, causing reaction at 80 to 200° C., preferably 120 to 160° C., and pulverizing the obtained product. Further, the prepolymer can be produced by supplying the above-mentioned raw materials to an extruder at 80 to 260° C., preferably 120 to 250° C., polymerizing the raw materials while kneading and transporting the raw materials in the extruder, and then extruding the produced product out of a die.

An elastomer can be obtained by a urethane prepolymer by causing reaction as follows: it can be obtained by reaction of the obtained isocyanate group-terminated urethane prepolymer and a low molecular weight polyol or polyamine; reaction of a hydroxyl group-terminated urethane prepolymer and the above-mentioned polyisocyanate; or reaction under the reaction conditions of the case of molding a mixture of a hydroxyl group-terminated urethane prepolymer and amino resin. The mixing ratio is preferably 1: (0.5 to 2), more preferably 1 (0.7 to 1.5) by mole ratio of the functional groups to be reacted. The reaction temperature is preferably 50 to 180° C. and more preferably 80 to 160° C. The reaction period is preferably 1 to 20 hours. The reaction can be checked by measuring the quantity of a functional group such as isocyanate group, hydroxyl, or the like by an isocyanate content titration analysis, IR analysis, or NMR analysis. Preferably, the moment of the completion is at the time when the terminal functional quantity becomes zero.

The amino resin to be used in that case may include, for example, alkyl-(1 to 8 carbon atoms) etherified melamine resin, alkyl-(1 to 8 carbon atoms) etherified benzoguanamine resin, alkyl-(1 to 8 carbon atoms) etherified urea resin, spiroguanamine resin, alkyl-(1 to 8 carbon atoms) etherified resin of diguanamine comprising two triazine rings bonded to a phenylene core and/or mixtures of two or more of them. Among them, preferable examples are alkyl etherified melamine resin, alkyl-etherified benzoguanamine resin, and a more preferable example is alkyl-etherified benzoguanamine resin.

The hydroxyl group-terminated urethane prepolymer can be reacted with a silane coupling agent. For example, an exchange reaction of alkoxy-(1 to 3 carbon atoms) silyl group and hydroxyl group is caused or reaction with hydroxyl group after silanol group production can be carried out. In the case of an epoxy group-containing silane coupling agent, an elastomer is formed by reaction of the epoxy group with the hydroxyl group. In the case of an epoxy group-terminated urethane prepolymer and an amino group-containing silane coupling agent, which will be described later, both amino group and alkoxysilyl group are reacted with the epoxy group, so that they are efficient for elastomer formation.

As such a silane coupling agent, alkoxy-(1 to 3 carbon atoms)silyl-containing silane coupling agents are preferable and examples of them are vinyl group-containing silane coupling agents (y-aminopropyltrimethoxysilane), epoxy group-containing silane coupling agents (y-glycidoxypropyltrimethoxysilane and the like), mercapto-containing silane coupling agents (y-mercaptopropyltrimethoxysilane and the like), amino group-containing silane coupling agents (y-aminoipropyltrimethoxysilane and the like) and the like and preferable examples are the epoxy group-containing silane coupling agents and the amino group-containing silane coupling agents. The reaction conditions maybe same as described above.

Further, functional groups different from those mentioned above may be introduced into the terminals of the urethane prepolymers. For example, as epoxy group-containing urethane elastomers, they can be produced by a method of introducing epoxy groups into the terminals by reaction of isocyanate groups of the isocyanate group-terminated urethane prepolymer with hydroxyl-containing epoxy compound such as glycidol; or a method of introducing epoxy groups by reaction of the hydroxyl group-terminated urethane prepolymer with epihalohydrin such as epichlorohydrin, epibromohydrin and the like. The amino-terminated urethane prepolymer can be obtained by reaction of isocyanate groups of the isocyanate group-terminated urethane prepolymer and an excess amount of a diamine.

Elastomers can be obtained by using the epoxy group-terminated urethane prepolymer and an epoxy resin curing agent. In such a case, an epoxylation reaction catalyst, a plasticizer, a curing promoting agent may be used.

Examples of epoxy resin curing agent are aliphatic amines such as ethylenediamine, diethylenetriamine, triethylenetetramine, xylylenediamine and the like; alicyclic amines such as 4,4′-diaminobiscyclohexylmethane, isophoronediamine, hydrogenated xylylenediamine and the like; aromatic amines such as aniline, dimethylaniline, diaminodiphenylmethane, phenylenediamine and the like; carboxylic acids and their anhydrides such as phthalic acid anhydride, hexahydrophthalic acid, tetrahydrophthalic acid and the like; BF₃ complexes; dicyanediamides; and imidazoles and the like. Examples of the epoxylation reaction catalyst are benzyldimethylamine, dimethylcyclohexylamine, dimethylethanolamine, triethylamine, tributylamine, trimethylamine, BF3-monomethylamine complex, BF3-benzyl amine complex, BF3-piperazine complex, BF3-aniline complex, aluminum isopropoxide and the like.

The amount of the epoxylation reaction catalyst to be used is 0.1 to 1% by mass and preferably 0.1 to 0.5% by mass in the entire resin composition.

Examples of the plasticizer are those exemplified above and the amount to be used may be also same.

Examples of a curing promoting agent are phenol, cresol, nonylphenol, styrene-reacted phenol, resorcinol, xylenol, salicylic acid, tertiary amine, trisdimethylaminomethylphenol and the like.

The method of producing the urethane elastomer from the epoxy group-containing urethane prepolymer is not particularly limited, and the epoxy group-containing urethane prepolymer, an epoxy curing agent, and if necessary, an epoxylation reaction catalyst are mixed, enclosed in a container, heated at 100 to 200° C., preferably 120 to 180° C. for several hours for reaction to obtain a half-cured resin which is then further cured for several hours to 10 days to obtain a completely cured resin.

Further, the epoxy group-containing urethane prepolymer may be cross-linked by reaction of it with polyols or thiols. The hydroxyl group-terminated urethane prepolymer may be cured by reaction of carboxyl group-terminated or acid anhydride-terminated urethane prepolymer with epoxy resin.

The epoxy resin is not particularly limited if the resin has two or more epoxy groups in a molecule and the following types (1) to (5) can be exemplified. The mixing ratio by mole of the hydroxyl groups and epoxy groups is preferably 1: (0.5 to 2) and more preferably 1:(0.7 to 1.5). (1) Glycidyl ether type:
(i) glycidyl ethers of dihydric phenols;
diglycidyl ethers of dihydric phenols of 6 to 30 carbon atoms, such as bisphenol F diglycidyl ether, bisphenol A diglycidyl ether, bisphenol B diglycidyl ether, bisphenol AD diglycidyl ether, bisphenol S diglycidyl ether, halogenated bisphenolA diglycidyl ether, tetrachlorobisphenol A diglycidyl ether, catechin diglycidyl ether, resorcinol diglycidyl ether, hydroquinone diglycidyl ether, 1,5-dihydroxynaphthalene diglycidyl ether, dihydroxybiphenyl diglycidyl ether, octachloro-4,4′-dihydroxybiphenyl diglycidyl ether, tetramethylbiphenyl diglycidyl ether, 9,9′-bis(4-hydroxyphenyl)fluorene diglycidyl ether, and diglycidyl ether obtained by reaction of bisphenol A 2 moles and epichlorohydrin 3 moles;
(ii) polyglycidyl ethers of tri- to hexa- or higher hydric, polyhydric phenols; polyglycidyl ethers of tri- to hexa- or higher hydric, polyhydric phenols of 6 to 50 carbon atoms or more and having 110 to 3,000 molecular weights, such as pyrogallol triglycidyl ether, dihydroxynaphthylcresol triglycidyl ether, tris (hydroxyphenyl) methane triglycidyl ether, dinaphthyltriol triglycidyl ether, tetrakis(4-hydroxyphenyl)ethane tetraglycidyl ether, p-glycidylphenyldimethyltriol bisphenol A glycidyl ether, trismethyl-teit-butyl-butylhydroxymethane triglycidyl ether, 4,4′-oxybis(1,4-phenylethyl)tetracresol glycidyl ether, 4,4′-oxybis(1,4-phenylethyl)phenyl glycidyl ether, bis (dihydroxynaphthalene) tetraglycidyl ether, glycidyl ethers of phenol or cresol novolak resins (molecular weight of 400 to 3,000); glycidyl ether of limonene phenol novolak resins (molecular weight of 400 to 3,000); polyglycidyl ethers of polyphenols (molecular weight of 400 to 3,000) obtained by condensation reaction of phenol and glyoxal, glutaraldehyde, or formaldehyde; polyglycidyl ethers of polyphenol with a molecular weight of 400 to 3,000 obtained by condensation reaction of resorcin and acetone;
(iii) diglycidyl ether of aliphatic dihydric alcohols;
diglycidyl ethers of diols of 2 to 100 carbon atoms and having a molecular weight of 62 to 3, 000, such as ethylene glycol diglycidyl ether, propylene glycol diglycidyl ether, tetramethylene glycol diglycidyl ether, 1,6-hexanediol diglycidyl ether, polyethylene glycol (molecular weight of 150 to 3,000) diglycidyl ether, polypropylene glycol (molecular weight of 180 to 3,000) diglycidyl ether, polytetramethylene ether glycol (molecular weight of 200 to 3, 000) diglycidyl ether, neopentyl glycol diglycidyl ether, diglycidyl ethers of AO [EO or PO (1 to 20 moles)] adduct of bisphenol A; and
(iv) polyglycidyl ethers of tri- to hexa- or higher hydric aliphatic alcohols; glycidyl ethers of tri- to hexa- or higher hydric polyhydric alcohols of 3 to 50 or more carbon atoms and having a molecular weight of 76 to 3,000, such as trimethylolpropane triglycidyl ether, glycerin triglycidyl ether, pentaerythritol tetraglycidyl ether, sorbitol hexaglycidyl ether, and poly(n=2 to 5) glycerol polyglycidyl ethers. (2) Glycidyl ester type:
diglycidyl esters of di-. to hexa- or higher aromatic polycarboxylic acids of 6 to 20 or more carbon atoms and diglycidyl esters of di- to hexa- or higher aliphatic or alicyclic polycarboxylic acids of 6 to 20 or more carbon atoms;
(i) as glycidyl esters of aromatic polycarboxylic acids, examples are glycidyl esters of phthalic acids such as phthalic acid diglycidyl ester, isophthalic acid diglycidyl ester, terephthalic acid diglycidyl ester, and trimellitic acid triglycidyl ester; and
(ii) as glycidyl esters of aliphatic or alicyclic polycarboxylic acids, examples are the esters obtained by hydrogenation of the aromatic cores of the above-mentioned phenol type glycidyl esters, dimer acid diglycidyl esters, diglycidyl oxalate, diglycidyl maleate, diglycidyl succinate, diglycidyl glutarate, diglycidyl adipate, diglycidyl pimelate, glycidyl (meth)acrylate (co)polymer (polymerization degree, for example, 2 to 10), tricarballylic acid triglycidyl esters; (3) Glycidylamine type:
glycidylamines of aromatic amines of 6 to 20 or more carbon atoms and having 2 to 10 or more active hydrogen atoms and glycidylamines of aliphatic, alicyclic or heterocyclic amines;
(i) as the glycidylamines of the aromatic amines, examples are N,N-diglycidylaniline, N,N-diglycidyltoluidine, N,N,N′,N′-tetraglycidyldiaminodiphenylmethane, N,N,N′,N′-tetraglycidyldiaminodiphenylsulfone, N,N,N′,N′-tetraglycidyldiethyldiphenylmethane, and N,N,O-triglycidylaminophenol;
(ii) as the glycidylamines of aliphatic amines, examples are N,N,N′,N′-tetraglycidylxylylenediamine and N,N,N′,N′-tetraglycidylhexamethylenediamine;
(iii) as the glycidylamines of alicyclic amines, examples are hydrogenated compounds of N,N,N′,N′-tetraglycidylxylylenediamine; and
(iv) as the glycidylamines of heterocyclic amines, an example is trisglycidylmelamine.
(4) Aliphatic epoxides:
aliphatic di- to hexa- or higher epoxides of 6 to 50 or more carbon atoms, such as epoxylated polybutadiene (molecular weight 170 to 3,000) with epoxy equivalent of 130 to 1,000 and epoxylated soybean oil (molecular weight 170 to 3,000).
(5) Alicyclic epoxides:
alicyclic epoxides of 6 to 50 or more carbon atoms having a molecular weight of 98 to 3,000 and comprising 2 to 4 or more epoxy groups, such asvinyl cyclohexene dioxide, limonene dioxide, dicyclopentadiene dioxide, bis(2,3-epoxycyclopentyl) ether, ethyleneglycol bis(epoxydicyclopentyl) ether, bis(3,4-epoxy-6-methylcyclohexylmethyl) adipate, and bis(3,4-epoxy-6-methylcyclohexylmethyl)butylamine; epoxides obtained by hydrogenation of the cores of epoxy compounds of the above-mentioned phenols. Compounds other than those exemplified (1) to (5) maybe usable if they are epoxy resins comprising active hydrogen and reactive glycidyl groups. Two or more of these polyepoxides and monoepoxides can be used in combination.

Among them, preferable examples are diglycidyl ethers of dihydric phenols (6 to 30 carbon atoms); polyglycidyl ethers of tri- to hexa- or higher hydric polyhydric phenols (6 to 50 carbon atoms) and further preferable examples are diglycidyl ethers of dihydric phenols (6 to 30 carbon atoms).

As described, a variety of functional groups can be introduced into the terminals of urethane polymers and elastomers can be produced by curing by various reactions. The reactions may be reactions other than described above. Among them, reaction by thermosetting is preferable and addition reaction with no solvent and volatile components is furthermore preferable. As the urethane polymers formed by such a reaction, urethane prepolymers to be supplied for molding materials are preferable. There are many commercialized products of urethane prepolymers and for example, Monotan (reaction type urethane prepolymer: manufactured by Compounding Ingredients Ltd.), Sanprene (reaction type and non-reaction type urethane prepolymer; manufactured by Sanyo Chemical Industries, Ltd.), and the like.

A production method of the guide wire of the invention include a method for resin-molding a tip end portion (a-2) of a guide wire comprising an inner core (a) composed of a main part portion (a-1) with a high rigidity and the tip end portion (a-2) smaller in diameter and lower in rigidity and integrally formed with the (a-1) and a high x-ray contrast unit (b) formed in the tip end portion (a-2), wherein the guide wire is produced by inserting the tip end portion (a-2) portion into a tube with a larger outer diameter than that of the tip end portion (a-2) and injecting a resin raw material into the tube for resin-molding the tip end portion (a-2) containing the high x-ray contrast unit (b) and then drawing out the tip end portion (a-2) from the tube.

At first, as the pretreatment for inserting the tip end portion (a-2) portion into the tube with a larger outer diameter than that of the tip end portion (a-2), it is preferable that the inner core and the high x-ray contrast unit (b) are washed with a solvent such as an alcohol (methanol, ethanol, isopropanol and the like), a ketone (acetone, methyl ethyl ketone, and the like), an ester (ethyl acetate, butyl acetate, and the like) for washing out adhering impurities and oils. Preferably, the washing may be carried out by immersion, stirring or spraying treatment at 10 to 100° C. for 10 minutes to 10 hours.

Further, the inner core (a) is preferably treated with a primer. As the primer, known primers may be used and those excellent in the adhesion to the metals composing the inner core (a) and the high x-ray contrast unit (b) are preferable. Particularly, the primer is preferable to have elasticity as same as the above-mentioned elastomer. Practical examples to be used as such a primer are materials same as the prepolymers exemplified above as the resin raw materials for the elastomers of olefin type, urethane type, epoxy type, acrylic type, latex and the like and in addition, cyanoacrylate type adhesive, silane coupling agent and the like can be used. As the practical examples, commercialized products such as ADEKA BONTIGHTER HUX-350 (water-based urethane resin: manufactured by AsahiDenka Kogyo K.K.), Silbond 49SF (manufactured by Compounding Ingredient Ltd.), Mitec NY-T-36 (NCO-containing urethane resin: manufactured by Mitsubishi Chemical Corporation), and Polytail HE (polyolefin resin: manufactured by Mitsubishi Chemical Corporation) can be exemplified.

Depending on the types of primers to be used, the primer treatment differs, and an example of the treatment method is carried out by immersing the inner core (a) and the high x-ray contrast unit (b) in a primer solution, or spraying or applying the primer solution to the inner core (a) and the high x-ray contrast unit (b); drying out the solvent used for diluting the primer at a normal temperature for 1 hour to overnight, and heating the resulting the inner core (a) and the high x-ray contrast unit (b) preferably at 50 to 200° C., more preferably 80 to 150° C., for 1 to 12 hours. The primer is preferably diluted based on necessity so as to use the primer with an adjusted concentration and viscosity. The concentration is preferably 0.1 to 10% by weight and the viscosity is preferably 1 to 200 mPa·s. The dried film thickness of the primer is preferably 0.05 to 30 μm and more preferably 0.15 to 10 μm.

The production method of the guide wire to be carried out after completion of such treatment will be described along with FIG. 1. The inner core 1 is inserted into a tube 4 made of resin with a length about 3 times as long as that of the tip end portion 2 so as to push the inner core 1 in such a manner that the most tip end of the inner core 1 is at a point of 2 to 10 cm from the outlet of the resin tube 4. The tip end of the resin tube 4 is extruded by about 2 to 10 cm from the tip end portion 2. The inner diameter of the resin tube 4 is same as the outer diameter of the inner core. The outer diameter of the resin tube 4 is preferably 0.5 to 1 mm. If the outer diameter of the inner core 1 is 0.31 mm, the inner diameter of the resin tube 4 is 0.31 mm and the outer diameter is 1 mm and if the outer diameter of the inner core 1 is 0.25 mm, the inner diameter of the resin tube 4 is 0.25 mm and the outer diameter is 1 mm. The material for the resin tube 4 is not particularly limited if it can be swollen with a solvent to be used later and for example, fluorocarbon, urethane, silicone, or olefin resins may be used.

The tip end part of the resin tube 4 is inserted into a tube 5 made of a metal (e.g. a stainless steel). The metal tube 5 is adjusted to have approximately same length as that of the tip end portion 2 of the inner core. The gap between the resin tube 4 and the metal tube 5 is sealed by a sealing member 6. The sealing member 6 is preferably urethane, fluorocarbon, or silicone rubber with elasticity, easy to handle, and further preferably it is made of the material same as the resin tube 4. That is because elastomers can be prevented from entering the gap between the metal tube 5 and the resin tube 4 and adhering to the resin tube 4 and thereby polluting the inner core and deteriorating the workability in the step thereafter.

The above-mentioned elastomer raw material (e.g. urethane prepolymer and its blends) is melted to have a melt viscosity of preferably 200 mPa·s or less and while the metal tube 5 being in the lower side, the melted elastomer is injected through the inlet of the resin tube 4 up to the taper boundary (around the upper part of 2). As the injection method, a method of injecting the elastomer up to the taper boundary based on the capillary phenomenon by keeping the metal tube 5 in the lower side and immersing it in the melted elastomer or a method of slowly filling the portion up to the taper boundary of the resin tube 4 with the elastomer by reducing the pressure from the opposite side (the upper side) of the metal tube 5 are available and the former is preferable. The temperature at the time of melting is proper not to cause the cross-linking reaction and to give a proper viscosity for making the elastomer possible to enter the resin tube 4 and it is preferably 50 to 100° C.

After the elastomer is injected, a plug 7 is plugged. The plug 7 is preferably made of a metal (e.g. a stainless steel). The plugging is for preventing the elastomer from spilling by the time of completion of molding. In the case of the reaction type elastomer, cross-linking reaction is preferably caused by heating. The heating method is carried out by using an electric furnace or a drying apparatus in such a manner that the plug portion is kept in the lower side. The heating temperature differs depending on the heating mechanism and preferably 50 to 200° C. and more preferably 80 to 150° C. and heating is preferably carried out for 1 to 12 hours. In this case, the temperature is required to be proper to avoid softening of the resin tube. The inner core in the portion of the resin tube is preferably pulled out after cooling to 50° C. or lower. In such a manner, a guide wire having the resin-molded portion at the terminal

can be obtained.

Another invention is a guide wire comprising the tip end portion (a-2) made of a metal powder-mixed rubber.

The metal powder to be used is the same as the above-mentioned metal powder having the high x-ray contrast property and preferably gold and platinum. The form of the metal powder is not particularly limited and it is preferably in form of particles so as not to damage the blood vessel even if the metal powder coming out of the surface of the rubber and spherical particles are more preferable. At the time of forming the metal powder-mixed rubber to be the tip (the most tip end) of the tip end portion (a-2), the rubber has to be smaller than the tip end part in order to semi-circularly project the rubber out of the most tip end part and it is preferably 0.25 to 0.31 mm.

The material of the rubber may be the same as that of the elastomer and preferably urethane elastomer and further preferably thermosetting urethane elastomer. The ratio of the elastomer forming the rubber and the metal powder is preferably (10:90) to (90:10) by weight and more preferably (15:85) to (50:50).

The form of the rubber is preferably semicircular. Because it is at the tip end part of the guide wire and therefore frequently brought into contact with the blood vessel and thus scarcely causes physical damages on the blood vessel.

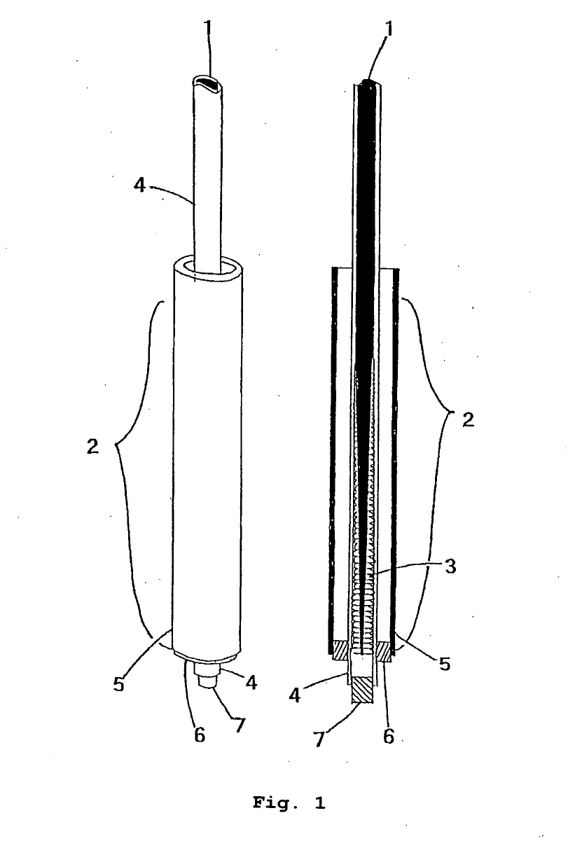

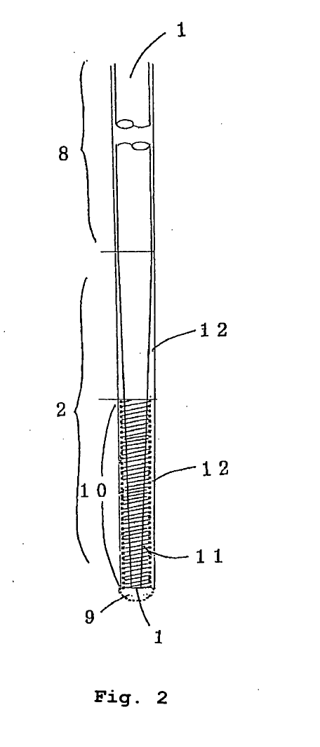

The production method may include mixing the metal powder with rubber, attaching a trace amount of the mixture to the tip end while keeping the mixture from coming out the diameter and keeping the tip end of the tip end portion (a-2) in the lower side, and gradually lifting the tip end portion (a-2). The operation is preferably carried out by observing with a magnifying glass. Further, the mixture is cured in the curing conditions same as those in the case of using a hot air drying apparatus. Further, at the time of integrally forming the above-mentioned resin and the coil, the plug 7 is plugged after the injection of the elastomer, a semi-circular recessed part may be used for plugging in place of the plug and after reaction by heating is carried out, the plug is taken off to form the rubber mixture by only one time heating. In such a manner, a metal powder-mixed rubber with a semi-circular shape at the tip can be formed (the tip end part in FIG. 2). The metal powder exists in the rubber and the rubber is same as the elastomer forming the tip endportion (a-2) of the guide wire and is extremely soft, hardly damages the blood vessel and safe as compared with a conventional wire with a silver solder at the most tip end. By the production method, a guide wire having the tip end having elasticity and composed of the high x-ray contrast unit (b) and the tip end portion (a-2) covered with the elastomer. In the case of the guide wire produced by such a production method, even if a doctor erroneously uses it and makes it in habitual form, it can easily be amended. Further, a guide wire with an outer diameter as extremely thin as 0.25 to 0.31 mm can be made available for practical use.

Next, a lubricating coating is formed on the entire or a part of the surface of the foregoing obtained guide wire. Preferably the entire surface is coated. The coating can be formed by treating the guide wire with an anti-thrombus coating material which can firmly be stuck to the substrate, forms a highly durable coating and gives good anti-thrombus property and in-water lubricating property and slimy property. When the guide wire is inserted into the tissues and the coeloms of a human body such as the blood vessel, the trachea, the urethra and the like, there occurs a problem that the thrombus adheres or the tissues stuck to the guide wire. Therefore, in order to avoid troubles in medical care at the time of insertion, the guide wire is required to lessen the damages and scratches by the contact with the tissues and mucous membranes and for that, it has been pointed out that a low friction material has to be used also for the guide wire. Therefore, it becomes effective to use the anti-thrombus coating material giving the above-mentioned functions.

In the invention, as the anti-thrombus coating material for forming the lubricating coating, conventionally used ones can be used. Practical examples are coating materials containing organic solvent and (1) polyvinyl ether-malefic anhydride copolymer, its partially esterified copolymer, and/or silicone-containing fluoroacrylate polymer (Japanese Patent No. 2,696,053); (2) two or more copolymers selected from N,N-dimethyl(meth)acrylamide, 2-hydroxyethyl (meth)acrylate, and 2-(perfluoroalkyl) ethyl (meth)acrylate (Japanese Patent Application Laid-Open No. 7-289630); (3) (2R,4R)-4-methyl-1-[N-((RS)-3-methyl-1,2,3,4-tetrahydro-8-quinolinesulfonyl)-L-alginyl]-2-piperidinedicarboxylic acid hydrate. In the invention, the lubricating coating is preferably an anti-thrombus coating containing polyvinyl ether-maleic anhydride copolymer, its partially esterified copolymer, and/or silicone-containing fluoroacrylate polymer. The production method of the anti-thrombus may be same as described in the above-mentioned document. Before the use of the above-mentioned anti-thrombus coating material, the above-mentioned primer maybe treated again. The treatment conditions are preferably same as those described above. In the case of using the above-mentioned anti-thrombus coating material, it is preferable to adjust the concentration and the viscosity by diluting the material with the above-mentioned solvent. The concentration is preferably 0.1 to 20% by weight and more preferably 0.2 to 10% by weight. The viscosity is preferably 1 to 200 mPa·s and more preferably 2 to 100 mPa·s. The dried coating film thickness of the anti-thrombus coating material is 0.05 to 30 pm, and more preferably 0.15 to 10 μm.

The obtained guide wire is subjected to immersion to the coating material up to a needed length, or spraying or brush application treatment with the material at a normal temperature to 50° C., dried at a normal temperature for 10 hours or long to overnight, and heated at 50 to 200° C., more preferably 80 to 150° C. for preferably 1 to 12 hours.

In the case of the anti-thrombus coating material of the above-mentioned (1), in order to provide the lubricating property, alkaline treatment is carried out. The guide wire coated with the ant-thrombus coating material is further subjected to immersion treatment in a preferably 0.01 to 1 N, more preferably 0.05 to 0.5 N alkaline solution of sodium hydroxide, potassium hydroxide, sodium carbonate, sodium hydrogen carbonate, or aqueous ammonia, at 10 to 60° C. for preferably 10 to 60 minutes, more preferably 20 to 40 minutes. After that, the guide wire is well washed with purified water such as distilled water or ion-exchanged water. In this case based on the necessity, it is effective to carry out washing by an ultrasonic washing apparatus preferably for 5 minutes or longer. After that the guide wire is dried at a normal temperature to 50° C. for 1 to 10 hours. By this operation, the guide wire having the lubricating coating can be obtained.

The guide wire of the invention has a lubricating coating with heat resistance and wear resistance and durability in an optional length range. Further, an extremely thin guide wire having an outer diameter as thin as 0.25 to 0.31 mm can be made available for practical use.

Hereinafter, the invention will be described along with Examples and Comparative Examples, however it is not intended that the invention be limited to these illustrated embodiments. Hereinafter, the part(s) denotes the part(s) by weight.

### PRODUCTION EXAMPLE 1

Sannix PP 1000 (polypropylene glycol with the number average molecular weight of 1,000; the ratio of terminal primary hydroxylation 3%; manufactured by Sanyo Chemical Industries, Ltd.) 87. 1 g and tris (pentafluorophenyl) borane 0.02 g were loaded into an autoclave with 200 ml capacity, made of a stainless steel and equipped with a stirring apparatus and a thermostat apparatus and while the reaction temperature being controlled at 60 to 70° C., propylene oxide 87.1 g was dropwise added for 12 hours and then aging was carried out at 65° C. for 3 hours. Next, after the reaction product was neutralized with an aqueous sodium hydroxide solution, Kyowaad 600 (synthesized silicate, manufactured by Kyowa Chemical Industry Co., Ltd.) 3.0 g and water were added at 70° C. for 1 hour. After the reaction product was taken out of the autoclave, it was filtered with a filter of 1 μm meshes and then dewatered to obtain a liquid-state polypropylene glycol (the number average molecular weight: 2,000) 156.8 g. The yield was 90%, the hydroxyl value was 55.9, and the ratio of the primary hydroxyl groups in the hydroxyl groups at the terminals was 69%.

This liquid-state polypropylene glycol 23 g and propylene oxide adduct of glycerin (the number average molecular weight: 5,000) 57 g were loaded into a reaction chamber, dewatered at 120° C. in reduced pressure of 30 mmHg to lower the water content of the mixture to 0.03% or less. Next, the mixture was cooled to 80° C. and HD 19.1 g was added to the reaction chamber and reaction was carried out at 80±5° C. for 4 hours to obtain a urethane prepolymer having a terminal NCO content 2.2%.

The urethane prepolymer 100 g, the above-mentioned polypropylene glycol (the number average molecular weight:

2,000) 62 g, and a curing promoting catalyst (monobutyltin triacetate) 0.01 g were kneaded by a planetary mixer for 30 minutes under reduced pressure to obtain two-component type elastomer resin raw material.

### PRODUCTION EXAMPLE 2

The liquid-state polypropylene glycol of Production Example 1 (the number average molecular weight: 2,000) 40 g and propylene oxide adduct of glycerin (the number average molecular weight: 5,000) 57 g were loaded into a reaction chamber, dewatered in the same manner as the latter half stage in the Production Example 1 at 120° C. in reduced pressure of 30 mmHg to lower the water content of the mixture to 0.03% or less. Next, the mixture was cooled to 80° C. and HDI 5.7 g was added to the reaction chamber and reaction was carried out at 80±5° C. for 4 hours to obtain a hydroxyl group-terminated urethane prepolymer (hydroxyl value: 4.2).

The urethane prepolymer 100 g and Cymel 303 (Mitsui-Saitec Corp: amino resin) 2 g were kneaded by a planetary mixer for 30 minutes under reduced pressure to obtain thermosetting elastomer resin raw material.

### PRODUCTION EXAMPLE 3

Glycol adipate polyester 183.8 g with a weight average molecular weight 1,750 and neopentyl glycol 1.5 g were loaded into a reaction chamber, dewatered at 120° C. in reduced pressure of 30 mmHg in the same manner as the latter half stage in the Production Example 1 to lower the water content of the mixture to 0.03% or less. Next, the mixture was cooled to 80° C. and HDI 18.5 g was added to the reaction chamber and reaction was carried out at 80±5° C. for 4 hours to obtain a hydroxyl group-terminated urethane prepolymer (hydroxyl value: 6.5).

The urethane prepolymer 100 g and Pestagon B-1530 (E-caprolactam blocked isocyanate, manufactured by Huls Corp.) 3 g were kneaded by a planetary mixer for 30 minutes under reduced pressure to obtain thermosetting elastomer resin raw material.

### PRODUCTION EXAMPLE 4

Hydroxyl group-terminated urethane prepolymer 100 g obtained in Production Example 3 and y-glycidoxypropyltrimethoxysilane 3 g were kneaded by a planetary mixer for 30 minutes under reduced pressure to obtain thermosetting elastomer resin raw material.

### PRODUCTION EXAMPLE 5

Under stirring condition, toluene 100 parts was loaded into a flask and heated to 120° C. and a mixed solution containing methyl methacrylate 35 parts, Fluowet MAE-812 [perfluoroalkylethyl (carbon atoms of perfluoroalkyl part; 6 to 12) methacrylate; Clariant Japan] 55 parts, styrene 20 parts, 3-mercapatopropyltrimethoxysilane 7 parts, azobis(isobutyronitrile) 3 parts, and toluene 5 parts was dropwise added for 3 hours and reaction was carried out at the same temperature for 2 hours. Further, azobis(isobutyronitrile) 0.3 part was added and reaction was carried out at the same temperature for 3 hours. After cooling to a room temperature, a silicone-containing f luoromethacrylate copolymer containing solid matter 52.5% and having a weight average molecular weight 1,200 was obtained.

GANTREZ AN-139 (polyvinyl ether/maleic anhydride copolymer; the weight average molecular weight 41,000; manufactured by GAF Co.) 4 g was mixed with methyl ethyl ketone 76 g and stirred and dissolved in therein. Next, the above obtained silicone-containing fluoromethacrylate copolymer 20 g was gradually added and stirred and mixed at 100° C. for 1 hour. After cooled to a room temperature, the obtained product was diluted with methanol/acetone (1/1; by volume) to obtain a coating solution with 5% solid matter.

### EXAMPLE 1

As an inner core, a core wire with 0.25 mm outer diameter and 1, 800 mm full length was tapered in the tip portion of 160 mm and the tip portion of 160 mm from the tip end was tapered to be narrow toward the tip and obtain an inner core with the outer diameter 0.04 mm at the most tip end. SUS 301-Ti, Ni alloy was used as the inner core material. Further a platinum coil was inserted into the taper part. The core wire was immersed in a solvent mixture of isopropanol/ethanol (1/1: volume ratio) and washed at a normal temperature for 30 minutes. After dried by being left at a normal temperature for 2 hours, the obtained core wire was treated with a primer.

As the primer, ADEKA BONTIGHTER HUx-350 (water-based urethane resin: manufactured by Asahi Denka Kogyo K. K.) diluted with water to adjust solid matter to be 5% was used. While the base part 10 cm of the core wire was left as it was, the rest portion up to the tip end was coated by immersion. After the core wire was pulled out and left still at a normal temperature for 12 hours, was set in an electric furnace and heated at 125° C. for 2 hours.

A silicone tube 200 mm with an inner diameter 0.25 mm and an outer diameter 1.0 mm was made ready and about 20 mm taper coil part at the tip end of the core wire was inserted into the tube. Further, a stainless pipe with an inner diameter 1.1 mm and an outer diameter 1.83 mm was made ready and the silicone tube was pushed in around 20 mm length of the inside of the silicone tube, that is up to the most tip end part. The tip end portion of 10 to 20 mm length between the stainless pipe and the silicone tube was sealed with a silicone plug (having a hole in the portion of the silicone tube).

“Monotan A-20” (reaction type urethane elastomer resin raw material: manufactured by Compounding Ingredients Ltd.) was set in a tank and melted at 70 to 90° C. and the portion from tip end to the taper boundary (160 mm from the tip end of the core wire) coated with the tube was immersed into the melted “Monotan A-20” to inject “Monotan A-20” from the lower part based on the capillary phenomenon. The resulting core wire was pulled out and the silicone tube at the tip end portion was plugged by a stainless plug.

Next, the core wire was set in an electric furnace while the plug part being in the lower side and thermosetting was carried out at 135° C. for 7 hours. The core wire was taken out of the electric furnace and cooled to a room temperature and then the stainless pipe was taken off and silicone tube was pulled out to obtain a guide wire A-1 having a specified structure of the invention. The guide wire comprised the core wire having a length of the full body about 1,800 mm and an outer diameter of 0.25 mm and a molded body of the urethane elastomer containing the platinum coil in the tip end portion with a length of 160 mm and an outer diameter of 0.25 mm. The tip end portion of the guide wire A-1 was found having the bending load about 4 g and the restorable load about 2 g. When the guide wire A-1 was x-ray-photographed, a high x-ray contrast image was obtained at the tip end part.

Further, the guide wire A-1 was hung while the tip end being kept in the lower side and a trace amount of a mixture of a gold powder (under 400 meshes) 80 parts and “Monotan A-20” 20 parts at 70° C. was stuck to the most tip end and then the guide wire was slowly lifted up. The resulting guide wire was set in an electric furnace and heated at 135° C. for 7 hours in nitrogen flow to cure the mixture and obtain a guide wire A′-1. As shown in FIG. 2, the tip end portion with a semi-circular shape was firmly attached. When the guide wire A′-1 was further x-ray-photographed, a high x-ray contrast image was obtained also at the most tip end part.

### EXAMPLE 2

The core wire used in this Example was same as that of Example 1, except that the outer diameter of the inner core was changed to be 0.31 mm from 0.25 mm. Washing was carried out in the same manner as Example 1.

Primer treatment was carried out in the same manner as Example 1, except that as a primer, “Silbond 49SF” (manufactured by Compounding Ingredient Ltd.) was used in place of “ADEKA BONTIGHTER HUX-350” used in Example 1.

The silicone tube used in this Example was same as that of Example 1, except that the outer diameter of the inner core was changed to be 0.31 mm from 0.25 mm. The same stainless pipe as that of Example 1 was used.

The elastomer was molded in the same manner as that of Example 1, except that the two-component type elastomer resin raw material produced in Production Example 1 was used in place of “Monotan A-20”. Thereafter, same operation was carried out to obtain a guide wire B-1.

The guide wire B-1 comprised the core wire having a length of the full body about 1,800 mm and an outer diameter of 0.31 mm and a molded body of the urethane elastomer containing the platinum coil in the tip end portion with a length of 160 mm and an outer diameter of 0.31 mm. The tip end portion of the guide wire B-1 was found having the bending load about 5 g and the restorable load about 3 g. When the guide wire B-1 was x-ray-photographed, a high x-ray contrast image was obtained at the tip end part.

Further, with respect to the semi-circular-shape rubber at the most tip end part, the two-component type elastomer resin raw material produced in Production Example 1 was used in place of “Monotan A-20” but the rest operation was carried out in the same manner as Example 1 to obtain B′-1. When the guide wire B′-1 was x-ray-photographed, a high x-ray contrast image was obtained also at the most tip end part.

### EXAMPLE 3

The core wire used in this Example was same as that of Example 1, except that the outer diameter of the inner core was changed to be 0.31 mm. Washing was carried out in the same manner as Example 1.

Primer treatment was carried out in the same manner as Example 1, except that as a primer, Polytail HE (polyolefin resin: manufactured by Mitsubishi Chemical Corporation) was used in place of “ADEKA BONTIGHTER HUX-350” used in Example 1.

The silicone tube used in this Example was same as that of Example 1, except that the inner 0.25 mm diameter of the tube was changed to be 0.31 mm. The same stainless pipe as that of Example 1 was used.

The elastomer was molded in the same manner as that of Example 1, except that the thermosetting type elastomer resin, raw material produced in Production Example 2 was used in place of “Monotan A-20”. Thereafter, same operation was carried out to obtain a guide wire C-1.

The guide wire C-1 comprised the core wire having a length of the full body about 1,800 mm and an outer diameter of 0.31 mm and a molded body of the urethane elastomer containing the platinum coil in the tip end portion with a length of 160 mm and an outer diameter of 0.31 mm. The tip end portion of the guide wire B-1 was found having the bending load about 5 g and the restorable load about 3 g. When the guide wire C-1 was x-ray-photographed, a high x-ray contrast image was obtained at the tip end part. Further, with respect to the semi-circular-shape rubber at the most tip end part, the thermosetting type elastomer resin raw material produced in Production Example 2 was used in place of “Monotan A-20” but the rest operation was carried out in the same manner as Example 1 to obtain C′-1. When the guide wire C′-1 was x-ray-photographed, a high x-ray contrast image was obtained also at the most tip end part.

### EXAMPLE 4

The elastomer was molded in the same manner as Example 1, except that the thermosetting type elastomer resin raw material produced in Production Example 3 was used in place of “Monotan A-20”. Thereafter, same operation was carried out to obtain a guide wire D-1 and a guide wire D′-1. When the guide wire D′-1 was x-ray-photographed, a high x-ray contrast image was obtained also at the most tip end part.

### EXAMPLE 5

The elastomer was molded in the same manner as Example 1, except that the thermosetting type elastomer resin raw material produced in Production Example 4 was used in place of “Monotan A-20”. Thereafter, same operation was carried out to obtain a guide wire E-1 and a guide wire E′-1. When the guide wire E′-1 was x-ray-photographed, a high x-ray contrast image was obtained also at the most tip end part.

### EXAMPLE 6

The guide wires A-1, B-1, C-1, D-1, and E-1 produced in Examples 1 to 5 were immersed in the coating solution obtained in Production Example 5 for 1 hour and after the coating solution was drained spontaneously, the wires were dried by air blow at a room temperature for 12 hours and heated at 100° C. for 7 hours in an electric furnace. After that, the wires were immersed in a 0.1N sodium hydroxide solution for 30 minutes, washed with flowing ion-exchanged water, dried at a room temperature for 10 hours to obtain guide wires A-2, B-2, C-2, D-2, and E-2 each having lubricating property. The guide wires were subjected to the following tests.

(Anti-Thrombus Test)

The inguinal part of a domestic rabbit was opened and the femoral artery was exposed and the anti-thrombus guide wires of the above-described Example 6 were inserted into the artery of the abdominal region from the exposed part. In the same manner, the guide wire A-1 of Example 1 having no coating of the above-mentioned coating material was inserted into the artery of the abdominal region of a domestic rabbit. On 36th day after retention, heparin 200 units were injected to both domestic rabbits and then slaughtered without bleeding blood. After the abdominal regions were opened and the thrombus adhesion state to each guide wire was observed.

No thrombus was observed at all in the guide wires A-2, B-2, C-2, D-2, and E-2. On the other hand, thrombus 60 mg was observed adhering to the guide wire A-1. From these results, the guide wires A-2, B-2, C-2, D-2, and E-2 were made clear that they had the ant-thrombus property. When the confirmation test was carried out by prolonging the retention period, no thrombus adhesion to the guide wires A-2, B-2, C-2, D-2, and E-2 was observed even after 60-day retention.

(Underwater Lubricating Test)

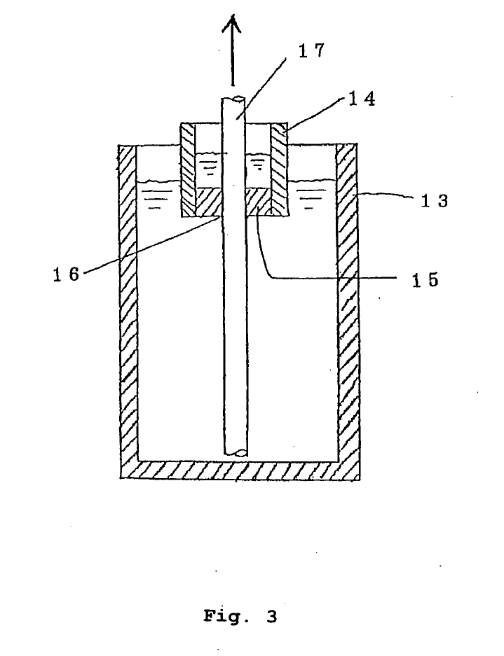

The underwater lubricating properties were compared for the guide wire A-2 of Example 6 and the guide wire A-1 of Example 1. An apparatus illustrated in FIG. 3 was used for the comparison test. In FIG. 3, a cylinder 14 having an outer diameter proper to be inserted into a cylindrical container 13 was concentrically attached to the upper part in the inside of the cylindrical container 13 and the gap between the bottom part of the cylindrical container 13 and the cylinder 14 was kept to be 100 mm. A silicone sheet 15 with a thickness of 8 mm was attached to the bottom part of the cylinder 14 and an aperture 16 with a diameter of 1.5 mm was opened in the center of the silicone sheet 15. A sample 17 of the guide wire was inserted in the aperture 16 and pushed until the tip end was brought into contact with the bottom part of the cylindrical container 13. The cylindrical container 13 and the cylinder 14 were filled with purified water. The upper end of the sample 17 was bonded to a tensile tester and pulled at 500 mm/min cross-head speed and the friction stress between the sample 17 and the silicone sheet 15 underwater was measured.

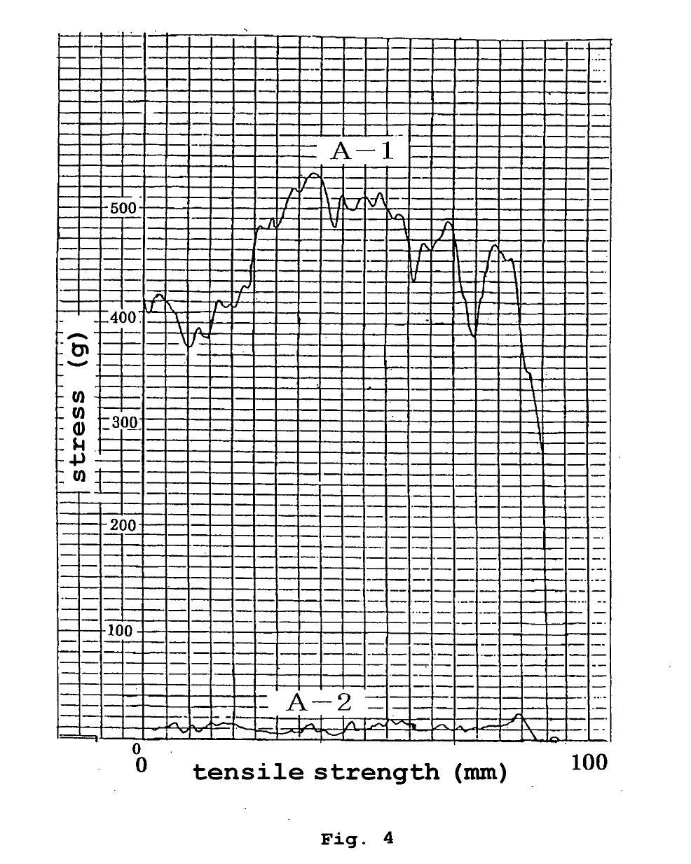

The test was carried out for the guide wire A-2 and the guide wire A-1 without coating, and the results are shown in FIG. 4. From the results, it was found that the guide wire A-2 of Example 6 had extremely low friction stress underwater and that it had uniform and excellent lubricating property in the full length.

(Slimy Test)

The guide wire A-2 of Example 6 and the guide wire A-1 of Example 1 were subject to the slimy test. After the respective samples were immersed in ice-water for 15 seconds and pulled out and the degree of the slimy feeling, the slimy feeling retention time, and the unevenness of the slimy feeling were evaluated by hand feeling. The guide wire A-2 of Example 6 showed high degree of the slimy touch and even repeated friction with hand in air for 5 minutes, the slimy touch did not lower and no heat was left by hand. Further, in the entire length of the guide wire, uneven slimy feeling was observed. On the other hand, the guide wire A-1 did not have slimy feeling even immediately after the pulling and when the wire was rubbed with a hand in air, it was immediately dried and shows high friction resistance and friction heat was felt by the hand.

Industrial Applicability of the Invention The guide wire and its production method of the invention have the following effects.

(1) A guide wire comprising an extremely thin inner core having an outer diameter as narrow as 0.25 to 0.31 mm can be made available for practical use.

(2) Since a gap is kept between the core wire and the coil in the main part portion at the tip end, the guide wire is easy to be bent, however the bending habit can easily be amended since the production method of the invention employs the immersion method.

(3) The guide wire has a durable lubricating coating in an optional length.

(4) Since the high x-ray contrast unit (the coil) and the resin are integrated, no blood enters in the coil and no thrombus is formed. Further, at the time of taking the guide wire off, the coil is prevented from expansion or contraction and therefore the guide wire is highly safe.

(5) The guide wire is soft and hardly damages the blood vessel since an elastomer is used for the metal powder-mixed rubber part at the most tip end.

Accordingly, the guide wire is not only useful as a conventional guide wire for insertion into the tissues and the coeloms of a human body such as the blood vessel, the trachea, the urethra and the like, but also for the blood vessel thinner than the blood vessels in the inside of the brain and the kidney.

1. A guide wire comprising an inner core (a) composed of a main body portion (a-1) with a high rigidity and a tip end portion (a-2) smaller in diameter and lower in rigidity than the (a-1) and integrally formed together with the (a-1) and a high x-ray contrast unit (b) formed at the tip end portion (a-2), wherein the tip end portion (a-2) is resin-molded with the high x-ray contrast unit (b) contained therein;

2. The guide wire according to claim 1, wherein the inner core (a) is treated with a primer.

3. The guide wire according to claim 1, wherein the resin used for the resin-molding is an urethane elastomer.

4. The guide wire according to claim 3, wherein the urethane elastomer is thermally cured.

5. The guide wire according to claim 1, wherein the tip end of the tip end portion (a-2) is made of a metal powder-mixed rubber.

6. The guide wire according to claim 1, wherein the surface is entirely or partially coated with a lubricating coating.

7. The guide wire according to claim 6, wherein the lubricating coating is polyvinyl ether-malefic anhydride copolymer, its partially esterified copolymer, and/or silicone-containing fluoroacrylate polymer.

8. A production method of a guide wire comprising an inner core (a) composed of a main body portion (a-1) with a high rigidity and a tip end portion (a-2) smaller in diameter and lower in rigidity than the (a-1) and integrally formed together with the (a-1) and a high x-ray contrast unit (b) formed at the tip end portion (a-2), by inserting a tip end portion (a-2) into a tube with a larger outer diameter than that of the portion (a-2) and injecting a resin raw material into the tube for resin-molding the tip end portion (a-2) containing the high x-ray contrast unit (b) and then drawing out the tip end portion (a-2) from the tube.

9. The production method of the guide wire according to claim 8, wherein the inner core (a) is treated with a primer.

10. The production method of the guide wire according to claim 8, wherein the resin used for the resin-molding is an urethane elastomer.

11. The production method of the guide wire according to claim 10, wherein the urethane elastomer is thermally cured.

12. The production method of the guide wire according o claim 8, wherein the tip end of the tip end portion (a-2) is made of a metal powder-mixed rubber.

13. The production method of the guide wire according to claim 8, wherein the surface is entirely or partially coated with a lubricating coating.

14. The production method of the guide wire according to claim 13, wherein the lubricating coating is polyvinyl ether-maleic anhydride copolymer, its partially esterified copolymer, and/or silicone-containing fluoroacrylate polymer.
